(19) United States
(12) Patent Application Publication
(10) Pub. No.: US 2025/0135735 A1
(43) Pub. Date: May 1, 2025

(54) Non-slip Mat and Its Production System and Method

(71) Applicant: ZHEJIANG SANMEN VIAIR INDUSTRY CO., LTD, Taizhou (CN)

(72) Inventor: Xiaopeng Yu, Taizhou (CN)

(21) Appl. No.: 18/415,698

(22) Filed: Jan. 18, 2024

(30) Foreign Application Priority Data
Oct. 25, 2023 (CN) 202311387407.X

(51) Int. Cl. B29D 7/00; A47G 27/02; B32B 5/02; B32B 27/12; B32B 27/30

(52) U.S. Cl. CPC B29D 7/00; A47G 27/0281; B32B 5/02; B32B 27/12; B32B 27/302; B32B 2274/00; B32B 2307/536; B32B 2307/744; B32B 2471/04

(57) ABSTRACT

The present invention discloses a non-slip mat and its production system and method used to produce non-slip mats. The non-slip mat is composed of a surface layer, a substrate, and a suction cup. There is a hot melt unit, a pressing unit, and a positioning unit. The hot melt unit is connected to the pressing unit, and consists of a hot melt device and a hot melt table. The present invention performs the pressing for the surface layer, the suction cup, and the molten substrate, so that the surface layer and suction cup are synchronously molten and welded together with the molten substrate at a time to form the non-slip mat, which achieves the one-piece welding molding for the suction cup, substrate and surface layer.

### CROSS REFERENCE TO RELATED APPLICATIONS

The present application claims the benefit of Chinese Patent Application No. 202311387407.X filed on Oct. 25, 2023, the contents of which are incorporated herein by reference in their entirety.

### TECHNICAL FIELD

The present invention relates to the field of floor mat technology, involving a non-slip mat and its production system and method.

### BACKGROUND ART

The indoor floor mat's anti-slip performance is particularly important for the elderly and children. There are frequent safety accidents in China where the users slip and fall due to the use of floor mats. Those made of rubber or latex foam materials have high safety risks on wet floors in toilets, kitchens, etc.

The floor mat can be prevented from slipping by setting the suction cup. Nowadays, the suction cup is usually connected to the floor mat through adhesive bonding, injection molding and other techniques, but most of floor mats are in the damp environment. After repeated use for many times, the suction cup is prone to fall off, which greatly affects the service life of floor mats with suction cups.

During the production process, the floor mats with suction cups require the manual participation in the fabric alignment process. Whether the fabric is aligned will affect the quality of the finished floor mats. However, after a long period of single repetitive work, the working personnel's vision and energy are prone to feel tired, so as to easily cause the problem of fabric misalignment, and affect the production efficiency and quality of floor mats with suction cups.

### SUMMARY OF THE INVENTION

The present invention provides a non-slip mat and its production system and method to overcome the shortcomings of existing technologies.

In order to achieve the above purpose, the present invention adopts the following technical proposal: A non-slip mat production system is used to produce non-slip mats. The non-slip mat is composed of a surface layer, a substrate, and a suction cup. There is a hot melt unit, a pressing unit, and a positioning unit. The hot melt unit is connected to the pressing unit, and consists of a hot melt device and a hot melt table. The hot melt device conducts the fusion for the substrate; the hot melt table is provided with the movable mould; the substrate is placed on the movable mould. The positioning unit carries out the positioning and installation for the suction cup; the surface layer and suction cup are respectively put on both sides of the molten substrate. The pressing unit performs the pressing for the surface layer and suction cup, so that they are synchronously molten and welded together with the substrate to form the non-slip mat.

Further, the movable mould is provided with a perforation. The positioning unit is equipped with several suction cup positioning holes. The suction cup positioning hole is loaded with the suction cup. The perforation of the movable mould is corresponding to the suction cup positioning hole.

Further, the pressing device includes an air cylinder, a chassis, a pressing plate, and a pressing table. The air cylinder is fixed on the chassis, the pressing plate is installed at the output end of the air cylinder, the pressing table is below the pressing plate, the pressing plate driven by the air cylinder vertically moves up and down over the pressing table, and the positioning unit is set on the pressing table.

Further, a visual unit is included, composed of a controller, as well as a first camera, a second camera, an image processor and an alarm connected to the controller. The first and second cameras are respectively connected to the image processor, and the controller can control the shooting of the first and second cameras. The first and second cameras collect images to generate corresponding image signals and send image signals to the image processor. The image processor can process the images and output the processing signals to the controller. Based on the processing signals, the controller outputs the trigger signals to the alarm so as to control the start of the alarm.

Further, a cooling mechanism is also included. It can cool the semi-finished non-slip mats.

Further, there is a trimming mechanism. It includes a conveyor mechanism, a stop plate, a third camera, a visual processing module, and a trimming machine. The conveyor mechanism is located between the pressing unit and the trimming machine, connected to the pressing unit and the trimming machine. The stop plate is placed on both sides of the conveyor mechanism, to limit the location of semi-finished non-slip mats during the delivery process. The third camera is set above the trimming area, to collect the fourth image of the semi-finished non-slip mat on the trimming machine and send it to the visual processing module. The visual processing module is connected to the controller. The visual processing module receives the image and processes the fourth image to judge if the semi-finished non-slip mat is located in the trimming area and on the to-be-cut line. The center of the trimming area coincides with the centers of two cutters. When the semi-finished non-slip mat is put in the trimming area, the centers of the two have the overlapping phenomenon.

A non-slip mat production method comprises the steps of:
Step 1: placing the movable mould and the substrate on the set position of the hot melt table;
Step 1.1: placing the movable mould on the hot melt;
Step 1.2: collecting the initial image of the movable mould with the first camera to judge if the movable mould is displaced; activating the alarm if yes, and conducting Step 1.1; implementing Step 1.3 if not;
Step 1.3: placing the substrate on the movable mould;
Step 1.4: collecting the first image of the substrate with the first camera to judge if the substrate is displaced; activating the alarm if yes, and conducting Step 1.3; implementing Step 2 if not;
Step 2: delivering the movable mould and the substrate to the hot melt device for hot melting through the hot melt table, until the substrate is removed after reaching the molten state;
Step 3: placing the surface layer on the set position of the substrate;
Step 4: moving the second integrated body composed of the movable mould, the substrate and the surface layer to the positioning unit of the loaded suction cup, to judge if the second integrated body is on the set position; conducting Step 5 if yes; adjusting the location of the second integrated body if not;
Step 5: controlling the downward pressing of the pressing plate through the air cylinder, and compressing the second integrated body, so that the surface layer and the suction cup are molten and welded with the molten substrate to obtain the semi-finished non-slip mat;
Step 6: cooling the semi-finished non-clip mat with the cooling mechanism; demoulding the semi-finished non-slip mat; utilizing the conveyor mechanism to deliver the semi-finished non-slip mat from the pressing unit to the trimming machine; using the stop plate to limit the location; moving the semi-finished non-slip mat with the trimming machine to the trimming area;
Step 7: using the trimming machine to cut the excess substrate along the to-be-cut line to obtain the finished non-slip mat;
Step 8: completing the operation.

Further, the operation in Step 1.2 to judge if the movable mould is displaced comprises the steps of:
Step 1.2.1: collecting the image A of the hot melt table with the first camera; processing the image A with the image processor to obtain the contour line B1 of the positioning line;
Step 1.2.2: collecting the initial image of the movable mould with the first camera; processing the initial image with the image processor to obtain the contour line B2 of the movable mould;
Step 1.2.3: calculating the distance h1 between the contour line B1 and the contour line B2 to obtain the maximum value of the distance h, and write it as h1a;
Step 1.2.4: comparing h1a with the first offset threshold Z1 that is set; judging that the movable mould is not displaced if h1a is not more than Z1; judging that the movable mould is displaced if h1a is more than Z1.

Further, the operation in Step 6 to judge if the semi-finished non-slip mat is located in the trimming area comprises the steps of:
Step 6.1: loading and preprocessing the third camera, so that the center of the trimming area captured by the third camera coincides with the centers of two cutters;
Step 6.2: collecting the fourth image of the semi-finished non-slip mat with the third camera; using the visual processing module to process the fourth image to obtain the contour line B9 of the surface layer in the fourth image;
Step 6.3: getting the central point O1 of the fourth image; carrying out the diagonal connection of the contour line B9; obtaining the central point O2 of the surface layer;
Step 6.4: obtaining the distance H between the central point O1 and the central point O2, and comparing H with the set threshold Z5; judging that the semi-finished non-slip mat is located in the trimming area, and conducting Step 7, if H is not more than Z5, and the center of the semi-finished non-slip mat coincides with the center of the trimming area; judging that the semi-finished non-slip mat is not located in the trimming area, and carrying out Step 6.5, if H is more than Z5, and the center of the semi-finished non-slip mat doesn't coincide with the center of the trimming area; regarding the cumulative number of times for displacement of semi-finished non-slip mats as n+1;
Step 6.5: calculating the actual distance H0 between the central point O1 and the central point O2 (H0=S×H: S is the magnification of the image captured by the third camera; H is the distance between the central point O1 and the central point O2 on the image, and His a known parameter); driving the movement H0 of the semi-finished non-slip mat with the conveyor of the trimming machine, and conducting Step 6.2;
Step 6.6: judging if the number of times (n) for displacement of semi-finished non-slip mats is more than the set threshold; judging that the conveyor mechanism or/and the conveyor of the trimming machine is faulted, if yes; using the controller to suspend the conveyor mechanism or/and the conveyor of the trimming machine, to activate the alarm; conducting Step 7, if not;
The non-slip mat made by using the non-slip mat production method is composed of a surface layer, a substrate, and a suction cup. The surface layer and suction cup are located on both sides of the substrate, and they are synchronously molten and welded together with the substrate.

In conclusion, the advantages of the present invention are as follows:
1) The present invention performs the pressing for the surface layer, the suction cup, and the molten substrate, so that the surface layer and suction cup are synchronously molten and welded together with the molten substrate at a time to form the non-slip mat. Compared with the conventional scheme that the existing suction cup is molded on the substrate which is attached to the surface layer through touch fasteners, this overcomes the disadvantage of the conventional scheme that cannot achieve the integrated welding and forming of the suction cup, substrate, and surface layer, which simplifies the non-slip mat production process, and improves the work efficiency. Compared with the conventional scheme, the hot melt and welding connection method enables the welding area among the suction cup, surface layer and substrate to have strong tear strength, which greatly enhances the service life of the non-slip mat.
2) The present invention monitors the manually laid substrate, surface layer and movable mould through the visual unit, able to effectively reduce the production efficiency and quality problem of floor mats with suction cups caused due to artificial factors, so as to greatly improve the production efficiency and quality of floor mats with suction cups.
3) The present invention automatically confirms the location of the to-be-cut line of the excess substrate through the trimming mechanism, able to achieve automatic trimming, so as to greatly improve the degree of automation for production of floor mats with suction cups.

### BRIEF DESCRIPTION OF THE DRAWINGS

FIG. 1 is the schematic diagram of the non-slip mat involved in the present invention.

FIG. 2 is the decomposition diagram of the non-slip mat involved in the present invention.

FIG. 3 is the schematic diagram of the initial image involved in the present invention.

FIG. 4 is the schematic diagram of the first image involved in the present invention.

FIG. 5 is the schematic diagram of the second image involved in the present invention.

FIG. 6 is the schematic diagram of the third image involved in the present invention.

FIG. 7 is the schematic diagram of the fourth image involved in the present invention.

### DETAILED DESCRIPTION

The embodiments of the present invention are described below by using the specific examples. The technicians in this field can easily understand other advantages and functions of the present invention according to the content disclosed in the specifications. The present invention can also be implemented or applied through other specific embodiments. The details in the specifications can be modified or altered based on different viewpoints and applications without deviating from the spirit of the present invention. It shall be noted that, in the absence of conflict, the following embodiments can be combined with the features in the embodiments.

It is important to point out that, the illustrations provided in the following embodiments only explain the basic conception of the present invention in a schematic manner, so they only show the components related to the present invention, and are not drawn according to the quantity, shape, and size of the components during the actual implementation. In practice, the shape, quantity, and proportion of the components can be changed at will, and the layout of the components may be more complicated.

In the embodiments of the present invention, all directional indications (including up, down, left, right, front, back, horizontal and vertical directions, etc.) are only used to explain the relative location and movement situation among components in a certain attitude. If the specific attitude has changes, the directional indications are modified accordingly.

Due to installation errors and other reasons, the parallel relationship involved in the embodiments of the present invention may actually be the approximate parallel relationship, and the vertical relationship may actually be the approximate vertical relationship.

### Embodiment 1

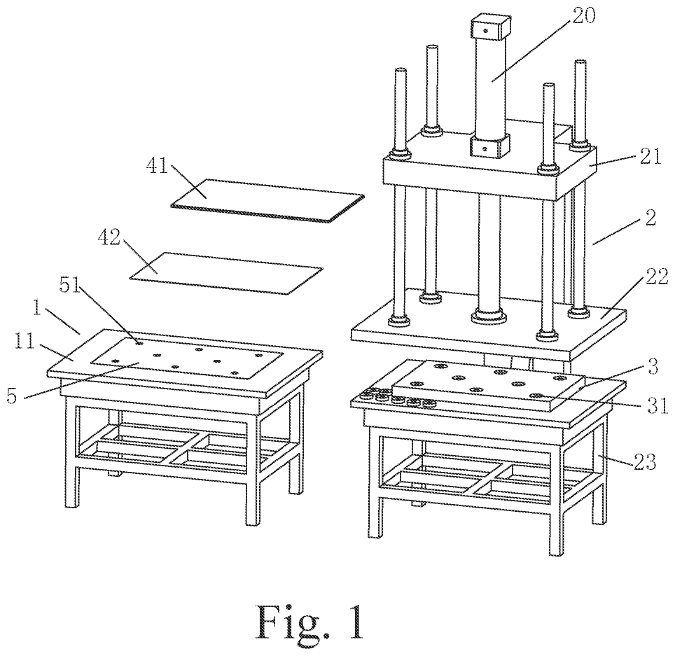

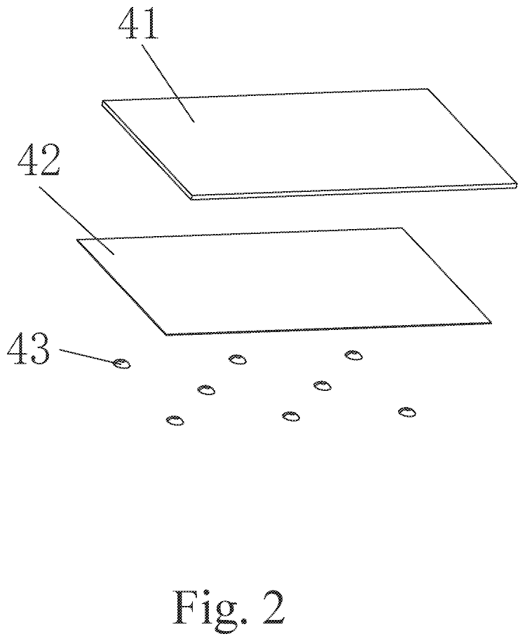

As shown in FIGS. 1-2, a non-slip mat production system is used to produce non-slip mats. The non-slip mat is composed of a surface layer 41, a substrate 42, and a suction cup 43. There is a hot melt unit 1, a pressing unit 2, a positioning unit 3 and a visual unit. The hot melt device 1 conducts the fusion for the substrate 42. The positioning unit 3 carries out the positioning and installation for the suction cup 5; the surface layer 41 and suction cup 5 are respectively put on both sides of the substrate 42. The pressing unit 2 performs the pressing for the surface layer 41 and suction cup 5, so that they are synchronously molten and welded together with the substrate 42 to form the non-slip mat.

The surface layer 41 is made of conventional fabric, usually located on the upper layer of the non-slip mat, with water absorption capacity, and it is treated with EVA setting adhesive for high-temperature molding. The substrate 42 is made of TPE elastomer, preferably styrene TPR coating material. The hardness of the substrate 42 is 50-60 HA; the substrate 42 has strong adhesion to the surface layer to avoid the detachment between the substrate 42 and the surface layer during washing.

In the embodiment, the hot melt unit 1 includes a hot melt device and a hot melt table 11. The hot melt device conducts the fusion for substrate 42. The hot melt table 11 is used to be loaded with the substrate 42. The substrate 42 is delivered through the hot melt table 11 to the hot melt device for hot melting. The judgment of the molten state of the substrate 42 in the embodiment is that the substrate 42 is sticky, and the surface is not degreased and begins to smoke.

The hot melt table 11 is provided with the positioning line. The location of the substrate 42 is set by using the positioning line.

The hot melt device adopts the conventional oven, heating plate and other heating devices to conduct the hot melting for the substrate 42. The hot melt temperature and hot melt time can be correspondingly adjusted according to the material of the substrate 42.

The production system includes a movable mould 5. The movable mould 5 is provided with a perforation 51. The movable mould 5 is loaded with the substrate 42. The outline dimension of the movable mould 5 is matched with that of the substrate 42. The hot melt unit 1 is connected to the pressing unit 2. The movable mould 5 is located between the hot melt unit 1 and the pressing unit 2. The operator moves the movable mould 5 on the hot melt unit 1, the molten substrate 42, and the surface layer 41 to the pressing unit 2.

The pressing device 2 includes an air cylinder 20, a chassis 21, a pressing plate 22, and a pressing table 23. The air cylinder 20 is fixed on the chassis 21, the pressing plate 22 is installed at the output end of the air cylinder 20, the pressing table 23 is below the pressing plate 22, the pressing plate 22 driven by the air cylinder 20 vertically moves up and down over the pressing table 23, and the positioning unit 3 is set on the pressing table 23.

The pressing unit 2 performs the pressing for the substrate 42, the surface layer 41 and the suction cup 43, so that the surface layer 41 and the suction cup 43 are synchronously molten and welded together with the molten substrate 41 at a time to form the semi-finished non-slip mat. Compared with the conventional scheme that the existing suction cup is molded on the substrate which is attached to the surface layer through touch fasteners, the present application overcomes the disadvantage of the conventional scheme that cannot achieve the integrated welding and forming of the suction cup, substrate, and surface layer, which simplifies the non-slip mat production process, and improves the work efficiency. Compared with the conventional scheme, the hot melt and welding connection method enables the welding area among the suction cup, surface layer and substrate to have strong tear strength, which greatly enhances the service life of the non-slip mat.

Preferably, the pressing pressure of the air cylinder 20 is set to be 3 MPa, and the pressing time is set to be 5 s, to ensure that the suction cup 43 and the surface layer 42 are fully molten and welded with the substrate 42 when the surface layer 41 is not flattened.

The positioning unit 3 is provided with several suction cup positioning holes 31, the perforation 51 of the movable mould is corresponding to the suction cup positioning hole 31, and the diameter of the perforation 51 is more than that of the suction cup 43, convenient to separate the movable mould 5 after the non-slip mat is cooled and shaped. The movable mould 5 is matched with the outline dimension of the positioning unit 3. When the movable mould 5 is attached to the positioning unit 3, as long as their side edges are aligned, it can be achieved to match the perforation 51 with the suction cup positioning hole 31, convenient for workers to match the perforation 51 with the suction cup positioning hole 31 one by one. The structure is simple, and the operation is convenient.

The suction cup positioning hole 31 is loaded with the suction cup 43. The suction cup 43 includes the fixed end connected to the substrate 42, and the adsorption end used for adsorption. The suction cup 43 is installed on the suction cup positioning hole 31, with the fixed end on the top and the adsorption end at the bottom. The fixed end of the suction cup 43 is aligned with the surface of the positioning unit 3, so that the fixed end of the suction cup 43 can be in direct contact with the molten substrate 42 carried by the positioning unit 3.

In order to ensure the stability of the loading of the suction cup 43 on the positioning unit 3, the suction cup positioning hole 31 is provided with the positioning block, and the outer diameter of the positioning block is less than the inner diameter of the absorption end of the suction cup 43. When the suction cup 43 is loaded, the positioning block is located inside the absorption end, to locate the loading of the suction cup 43.

The visual unit is composed of a controller, as well as a first camera, a second camera, an image processor and an alarm connected to the controller. The first and second cameras are respectively connected to the image processor, and the controller can control the shooting of the first and second cameras. The first and second cameras collect images to generate corresponding image signals and send image signals to the image processor. The image processor can process the images and output the processing signals to the controller. Based on the processing signals, the controller outputs the trigger signals to the alarm so as to control the start of the alarm.

The first camera is set over the hot melt table 11, used to collect the images of the hot melt table 11, including the initial image of the movable mould 5 on the hot melt table 11, the first image of the first integrated body constituted due to the connection between the movable mould 5 and the substrate 42, and the second image of the second integrated body formed by attaching the surface layer 41 on the first integrated body. The image processor receives the image and processes the initial image, the first image and the second image to judge if the location of the movable mould 5, the substrate 42 and the surface layer 41 is correct. If it is not on the set position, the alarm will be activated to remind the working personnel to conduct the rearrangement.

The second camera is located above the positioning unit 3, used to collect the third image of the second integrated body on the positioning unit 3. The image processor receives the third image and processes the third image to judge if the location of the second integrated body is correct. If it is not on the set position, the alarm will be activated to remind the working personnel to conduct the rearrangement.

The production system also includes a cooling mechanism. The cooling mechanism cools the semi-finished non-slip mat to 60° C. The semi-finished non-slip mat is demoulded after cooling.

The production system also contains a trimming mechanism that cuts the excess substrate 42 on the semi-finished non-slip mat to obtain the finished non-slip mat. It includes a conveyor mechanism, a stop plate, a third camera, a visual processing module, and a trimming machine. The conveyor mechanism is located between the pressing unit 2 and the trimming machine, connected to the pressing unit 2 and the trimming machine. The conveyor mechanism delivers the semi-finished non-slip mat from the pressing unit 2 to the trimming machine. The stop plate is placed on both sides of the conveyor mechanism, to limit the location of semi-finished non-slip mats during the delivery process, so as to prevent the deviation of semi-finished non-slip mats. The trimming machine is provided with the conveyor, to move the semi-finished non-slip mat to the trimming area. The third camera is set above the trimming area, to collect the fourth image of the semi-finished non-slip mat on the trimming machine and send it to the visual processing module. The visual processing module is connected to the controller. The visual processing module receives the image and processes the fourth image to judge if the semi-finished non-slip mat is located in the trimming area and on the to-be-cut line. The center of the trimming area coincides with the centers of two cutters. When the semi-finished non-slip mat is put in the trimming area, the centers of the two have the overlapping phenomenon. If it is not in the trimming area, and the conveyor of the trimming machine drives the semi-finished non-slip mat to move the corresponding distance to check if the semi-finished non-slip mat is in the trimming area, or the conveyor mechanism or/and the conveyor of the trimming machine is judged to be faulted due to multiple dislocation of semi-finished non-slip mats, then the controller suspends the conveyor mechanism or/and the conveyor of the trimming machine, to activate the alarm.

The trimming machine includes a cutter, a cutter displacement mechanism, a cutting rotation mechanism, and a cutting drive mechanism. There are two cutters that are respectively connected to the cutter displacement mechanism. The cutter displacement mechanism controls the movement of the cutter to the position of the to-be-cut line; it is put in the cutting rotation mechanism that controls the rotation of the cutter and the cutter displacement mechanism by 90°. The cutting rotation mechanism is located in the cutting drive mechanism that controls the downward movement of the cutter along the to-be-cut line to obtain the finished non-slip mat.

During the implementation process of the embodiment, the movable mould 5 is placed on the hot melt table 11, the first camera collects the initial image of the movable mould 5 on the hot melt table 11, and the image processor can process the initial image, to judge if the movable mould 5 is on the set position. The set position of the movable mould 5 is that the movable mould 5 is located within the positioning line of the hot melt table 11; if not, the alarm is activated to remind the working personnel to conduct the rearrangement, until the movable mould 5 is on the set position. The substrate 42 is placed on the movable mould 5. The first camera collects the first image of the first integrated body. The image processor can process the first image, to judge if the location of the substrate 42 on the movable mould 5 is on the set position. The set position of the substrate 42 is that the substrate 42 is aligned with the movable mould 5; if not, the alarm is activated to remind the working personnel to conduct the rearrangement, until the substrate 42 is located on the set position. The hot melt table 11 delivers the movable mould 5 and the substrate 42 to the hot melt device for hot melting. When the substrate 42 is in a molten state, the movable mould 5 and the substrate 42 are separated from the hot melt device. The surface layer 41 is placed on the molten substrate 42. The first camera collects the second image of the second integrated body, and the image processor can process the second image to judge if the surface layer 41 is on the set position; if not, the alarm is activated to remind the working personnel to conduct the rearrangement, until the surface layer 41 is located on the set position. The surface layer 41 is set to be in the middle of the substrate 42. The suction cup 43 is loaded on the positioning unit 3. The second integrated body moves to the positioning unit 3. The second camera collects the third image. The image processor can process the third image, to judge if the second integrated body is on the set position; if not, the alarm is activated to remind the working personnel to conduct the rearrangement, until the second integrated body is located on the set position. The set position of the second integrated body can ensure that the movable mould 5 is aligned with the positioning unit 3. At this time, the perforation 51 of the movable mould 5 is corresponding to the suction cup positioning hole 31 of the positioning unit 3. It is required to start the air cylinder 20, press down the pressing plate 22, and compress the second integrated body, so that the surface layer 41 and the suction cup 42 are molten and welded with the molten substrate 41 to obtain the semi-finished non-slip mat. The cooling mechanism cools the semi-finished non-slip mat. The semi-finished non-slip mat is demoulded after cooling. The trimming mechanism cuts the excess substrate 42 on the semi-finished non-slip mat to obtain the finished non-slip mat.

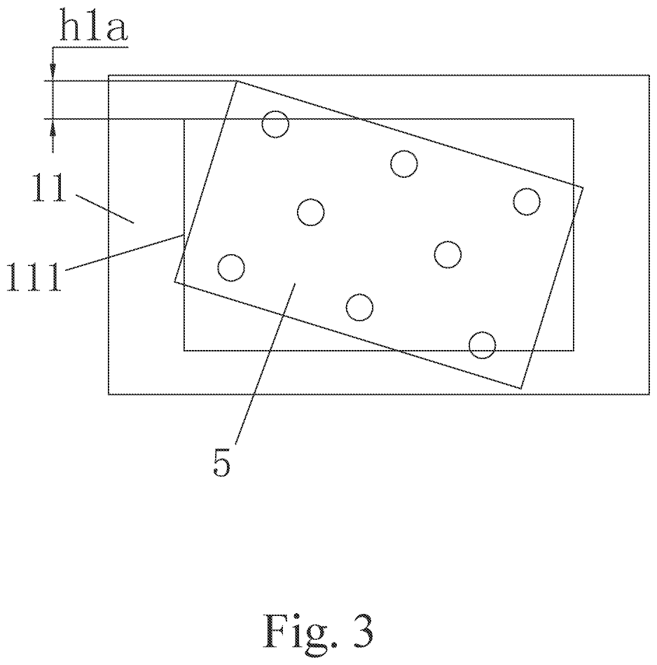

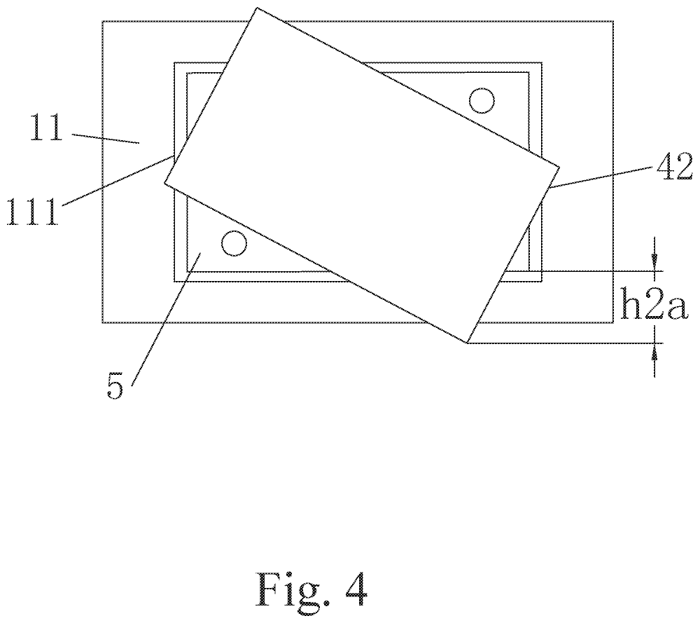

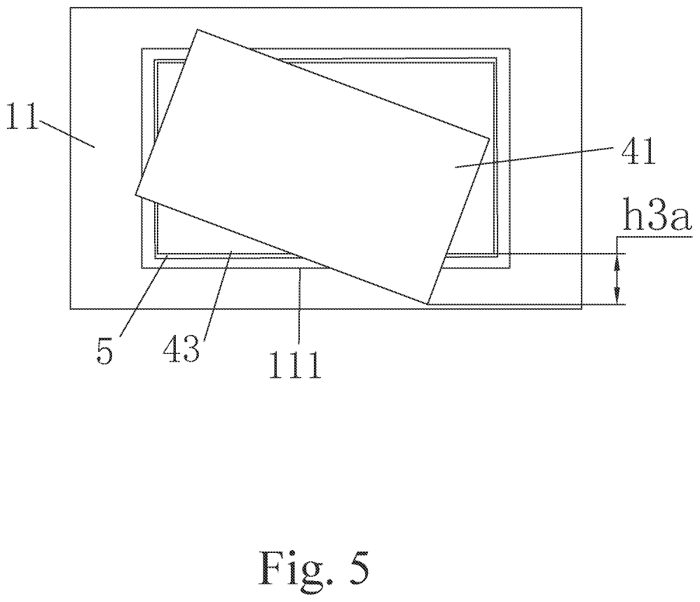

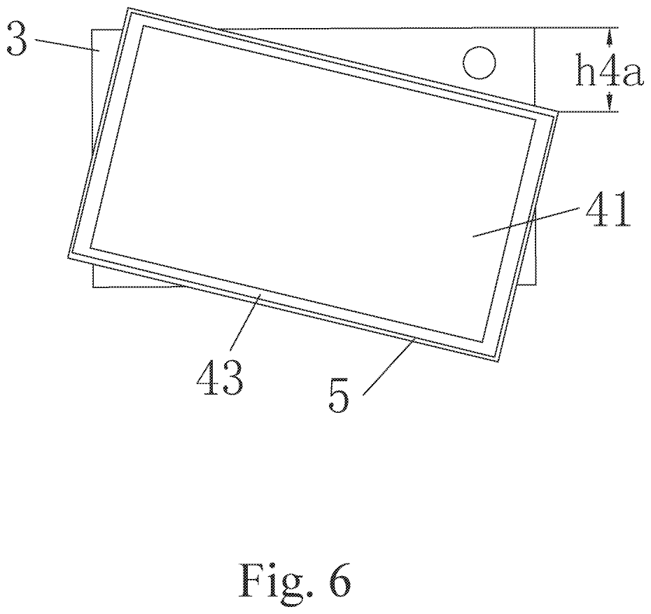

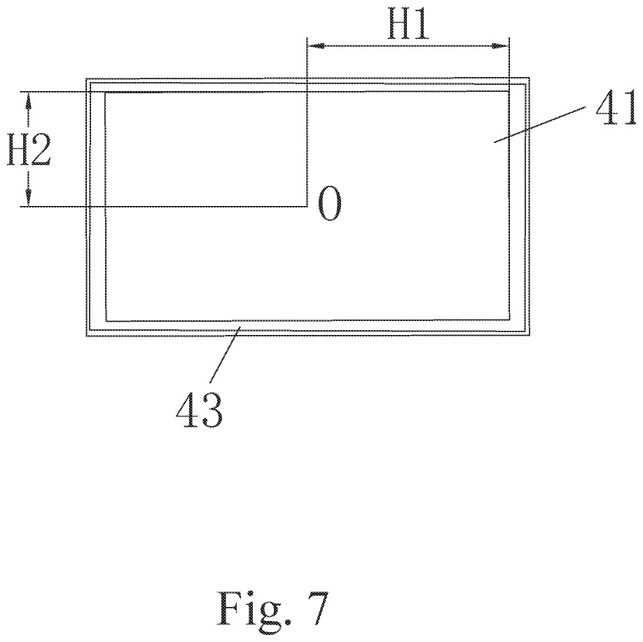

As shown in FIGS. 3-7, the present application also provides a non-slip mat production method. Based on the above non-slip mat production system, it comprises the steps of:
Step 1: placing the movable mould 5 and the substrate 42 on the set position of the hot melt table 11;
Step 2: delivering the movable mould 5 and the substrate 42 to the hot melt device for hot melting through the hot melt table 11, until the substrate 42 is removed after reaching the molten state;
Step 3: placing the surface layer 41 on the set position of the substrate 42;
Step 4: moving the second integrated body composed of the movable mould 5, the substrate 42 and the surface layer 41 to the positioning unit 3 of the loaded suction cup 43, to judge if the second integrated body is on the set position; conducting Step 5 if yes; adjusting the location of the second integrated body if not;
Step 5: controlling the downward pressing of the pressing plate 22 through the air cylinder 20, and compressing the second integrated body, so that the surface layer 41 and the suction cup 43 are molten and welded with the molten substrate 41 to obtain the semi-finished non-slip mat;
Step 6: cooling the semi-finished non-clip mat with the cooling mechanism; demoulding the semi-finished non-slip mat; utilizing the conveyor mechanism to deliver the semi-finished non-slip mat from the pressing unit 2 to the trimming machine; using the stop plate to limit the location; moving the semi-finished non-slip mat with the trimming machine to the trimming area;
Step 7: using the trimming machine to cut the excess substrate 42 along the to-be-cut line to obtain the finished non-slip mat;
Step 8: completing the operation.

In Step 1, the specific operation to place the movable mould 5 and the substrate 41 on the set position of the hot melt table 11 comprises the steps of:
Step 1.1: placing the movable mould 5 on the hot melt 11;
Step 1.2: collecting the initial image of the movable mould 5 with the first camera to judge if the movable mould 5 is displaced; activating the alarm if yes, and conducting Step 1.1; implementing Step 1.3 if not;
Step 1.3: placing the substrate 42 on the movable mould 5;
Step 1.4: collecting the first image of the substrate 42 with the first camera to judge if the substrate 42 is displaced; activating the alarm if yes, and conducting Step 1.3; implementing Step 2 if not;
In Step 1.2, the operation to judge if the movable mould 5 is displaced comprises the steps of:
Step 1.2.1: collecting the image A of the hot melt table 11 with the first camera; processing the image A with the image processor to obtain the contour line B1 of the positioning line 111;
Step 1.2.2: collecting the initial image of the movable mould 5 with the first camera; processing the initial image with the image processor to obtain the contour line B2 of the movable mould 5;
Step 1.2.3: calculating the distance h1 between the contour line B1 and the contour line B2 to obtain the maximum value of the distance h, and write it as h1a;
Step 1.2.4: comparing h1a with the first offset threshold Z1 that is set; judging that the movable mould is not displaced if h1a is not more than Z1; judging that the movable mould is displaced if h1a is more than Z1.

In Step 1.4, the specific operation to judge if the substrate 42 is displaced comprises the steps of:
Step 1.4.1: using the first camera to collect the initial image of the movable mould 5 that is not displaced; processing the initial image with the image processor to obtain the contour line B3 of the movable mould 5;
Step 1.4.2: collecting the first image of the substrate 42 with the first camera; processing the first image with the image processor to obtain the contour line B4 of the substrate 42;
Step 1.4.3: calculating the distance h2 between the contour line B3 and the contour line B4 to obtain the maximum value of the distance h2, and write it as h2a;
Step 1.4.4: comparing h2a with the second offset threshold Z2 that is set; judging that the substrate 42 is not displaced if h2a is not more than Z2; judging that the substrate 42 is displaced if h2a is more than Z2.

In Step 3, the operation to place the surface layer 41 on the set position of the substrate 42 comprises the steps of:
Step 3.1: using the first camera to collect the first image of the substrate 42 that is not displaced; processing the first image with the image processor to obtain the contour line B5 of the substrate 42;
Step 3.2: collecting the second image of the surface layer 41 with the first camera; processing the second image with the image processor to obtain the contour line B6 of the surface layer 41.
Step 3.3: calculating the distance h3 between the contour line B5 and the contour line B6 to obtain the maximum value of the distance h3, and write it as h3a;
Step 3.4: comparing h3a with the third offset threshold Z3 that is set; judging that the surface layer 41 is located on the set position if h3a is not more than Z3; judging that the surface layer 41 is displaced if h3a is more than Z3; adjusting the location of the surface layer 41, and conducting Step 3.1;
In Step 4, the specific operation to judge if the second integrated body is located on the set position comprises the steps of:
Step 4.1: collecting the image C of the positioning unit 3 with the second camera; processing the image C with the image processor to obtain the contour line B7 of the positioning unit 3;
Step 4.2: collecting the third image of the second integrated body with the second camera; processing the third image with the image processor to obtain the contour line B8 of the movable mould 5 in the second integrated body;
Step 4.3: calculating the distance h4 between the contour line B7 and the contour line B8 to obtain the maximum value of the distance h4, and write it as h4a;
Step 4.4: comparing h4a with the fourth offset threshold Z4 that is set; judging that the second integrated body is located on the set position if h4a is not more than Z4; judging that the second integrated body is displaced if h4a is more than Z4.

In Step 6, the operation to judge if the semi-finished non-slip mat is located in the trimming area comprises the steps of:
Step 6.1: loading and preprocessing the third camera, so that the center of the trimming area captured by the third camera coincides with the centers of two cutters;
Step 6.2: collecting the fourth image of the semi-finished non-slip mat with the third camera; using the visual processing module to process the fourth image to obtain the contour line B9 of the surface layer in the fourth image;
Step 6.3: getting the central point O1 of the fourth image; carrying out the diagonal connection of the contour line B9; obtaining the central point O2 of the surface layer;
Step 6.4: obtaining the distance H between the central point O1 and the central point O2, and comparing H with the set threshold Z5; judging that the semi-finished non-slip mat is located in the trimming area, and conducting Step 7, if H is not more than Z5, and the center of the semi-finished non-slip mat coincides with the center of the trimming area; judging that the semi-finished non-slip mat is not located in the trimming area, and carrying out Step 6.5, if H is more than Z5, and the center of the semi-finished non-slip mat doesn't coincide with the center of the trimming area; regarding the cumulative number of times for displacement of semi-finished non-slip mats as n+1;
Step 6.5: calculating the actual distance H0 between the central point O1 and the central point O2 (H0=S×H: S is the magnification of the image captured by the third camera; H is the distance between the central point O1 and the central point O2 on the image, and H is a known parameter); driving the movement H0 of the semi-finished non-slip mat with the conveyor of the trimming machine, and conducting Step 6.2;
The stop plate in the embodiment effectively prevents the semi-finished non-slip mat from tilting, so only the straight-line distance between the central point O1 and the central point O2 needs to be considered;
Step 6.6: judging if the number of times (n) for displacement of semi-finished non-slip mats is more than the set threshold; judging that the conveyor mechanism or/and the conveyor of the trimming machine is faulted, if yes; using the controller to suspend the conveyor mechanism or/and the conveyor of the trimming machine, to activate the alarm; conducting Step 7, if not;
The specific operation of Step 7 comprises the steps of:
Step 7.1: collecting the fourth image of the semi-finished non-slip mat with the third camera; processing the fourth image with the image processor to obtain the contour line B10 and the central point O of the surface layer 41;
Step 7.2: obtaining the distance H1 and H2 between the contour line B10 and the central point O along the length and width directions;

L=H1×S; W=H2×S;
Step 7.3: calculating the actual distance; writing the actual distance between the contour line B10 and the central point O in the length direction as L; writing the actual distance between the contour line B10 and the central point O in the width direction as W; regarding the magnification of the image captured by the third camera as S:

L=H1×S; W=H2×S;
Step 7.4: calculating the distance of the cutter moving in the length direction of the surface layer 41;
In the embodiment, two cutters are symmetrically distributed around the center of the trimming area. The distance between the cutter and the center of the trimming area is set to be Q. The central point O of the surface layer 41 coincides with the center of the trimming area. The distance of the cutter moving in the length direction of the surface layer 41 is set to be L1, L1=L−Q;
Step 7.5: using the cutter displacement mechanism to control the movement of the cutter from L1 to the to-be-cut line in the length direction of the surface layer 41;
Step 7.6: controlling the downward movement of the cutter with the cutting drive mechanism to cut the edge along the to-be-cut line;
Step 7.7: controlling the cutter with the cutting rotation mechanism to rotate 90°;
Step 7.8: calculating the distance of the cutter moving in the width direction of the surface layer 41;
The distance of the cutter moving in the width direction of the surface layer 41 is set to be W1 (W1=W−Q);
Step 7.9: utilizing the cutter displacement mechanism to control the movement of the cutter from L1 to the to-be-cut line in the width direction of the surface layer 41;
Step 7.10: controlling the downward movement of the cutter with the cutting drive mechanism to cut the edge along the to-be-cut line.

Obviously, the described embodiments are only part of the embodiments of the present invention, not all of them. Based on the embodiments of the present invention, all other embodiments obtained by general technicians without creative labor shall fall within the protection scope of the present invention.

What is claimed is:

1. A non-slip mat production system used to produce the non-slip mat composed of a surface layer, a substrate, and a suction cup, wherein there is a hot melt unit, a pressing unit and a positioning unit, the hot melt unit is connected to the pressing unit, and consists of a hot melt device and a hot melt table, the hot melt device conducts the fusion for the substrate, the hot melt table is provided with the movable mould, the substrate is placed on the movable mould, the positioning unit carries out the positioning and installation for the suction cup, the surface layer and suction cup are respectively put on both sides of the molten substrate, and the pressing unit performs the pressing for the surface layer and suction cup, so that they are synchronously molten and welded together with the substrate to form the non-slip mat.

2. The non-slip mat production system described in claim 1, wherein the movable mould is provided with a perforation, the positioning unit has several suction cup positioning holes, the suction cup positioning hole is loaded with the suction cup, and the perforation of the movable mould is corresponding to the suction cup positioning hole.

3. The non-slip mat production system described in claim 1, wherein the pressing device includes an air cylinder, a chassis, a pressing plate, and a pressing table; the air cylinder is fixed on the chassis, the pressing plate is installed at the output end of the air cylinder, the pressing table is below the pressing plate, the pressing plate driven by the air cylinder vertically moves up and down over the pressing table, and the positioning unit is set on the pressing table.

4. The non-slip mat production system described in claim 1, wherein a visual unit is included, composed of a controller, as well as a first camera, a second camera, an image processor and an alarm connected to the controller; the first and second cameras are respectively connected to the image processor, and the controller can control the shooting of the first and second cameras; the first and second cameras collect images to generate corresponding image signals and send image signals to the image processor; the image processor can process the images and output the processing signals to the controller; based on the processing signals, the controller outputs the trigger signals to the alarm so as to control the start of the alarm.

5. The non-slip mat production system described in claim 1, wherein it includes a cooling mechanism which cools the semi-finished non-slip mat.

6. The non-slip mat production system described in claim 1, wherein there is a trimming mechanism that includes a conveyor mechanism, a stop plate, a third camera, a visual processing module, and a trimming machine; the conveyor mechanism is located between the pressing unit and the trimming machine, connected to the pressing unit and the trimming machine; the stop plate is placed on both sides of the conveyor mechanism, to limit the location of semi-finished non-slip mats during the delivery process; the third camera is set above the trimming area, to collect the fourth image of the semi-finished non-slip mat on the trimming machine and send it to the visual processing module; the visual processing module is connected to the controller; the visual processing module receives the image and processes the fourth image to judge if the semi-finished non-slip mat is located in the trimming area and on the to-be-cut line; the center of the trimming area coincides with the centers of two cutters; when the semi-finished non-slip mat is put in the trimming area, the centers of the two have the overlapping phenomenon.

7. A non-slip mat production method, wherein it comprises the steps of:
step 1: placing the movable mould and the substrate on the set position of the hot melt table;
step 1.1: placing the movable mould on the hot melt;
step 1.2: collecting the initial image of the movable mould with the first camera to judge if the movable mould is displaced; activating the alarm if yes, and conducting step 1.1; implementing step 1.3 if not;
step 1.3: placing the substrate on the movable mould;
step 1.4: collecting the first image of the substrate with the first camera to judge if the substrate is displaced; activating the alarm if yes, and conducting step 1.3; implementing step 2 if not;
step 2: delivering the movable mould and the substrate to the hot melt device for hot melting through the hot melt table, until the substrate is removed after reaching the molten state;
step 3: placing the surface layer on the set position of the substrate;
step 4: moving the second integrated body composed of the movable mould, the substrate and the surface layer to the positioning unit of the loaded suction cup, to judge if the second integrated body is on the set position; conducting step 5 if yes; adjusting the location of the second integrated body if not;
step 5: controlling the downward pressing of the pressing plate through the air cylinder, and compressing the second integrated body, so that the surface layer and the suction cup are molten and welded with the molten substrate to obtain the semi-finished non-slip mat;
step 6: cooling the semi-finished non-clip mat with the cooling mechanism; demoulding the semi-finished non-slip mat; utilizing the conveyor mechanism to deliver the semi-finished non-slip mat from the pressing unit to the trimming machine; using the stop plate to limit the location; moving the semi-finished non-slip mat with the trimming machine to the trimming area;
step 7: using the trimming machine to cut the excess substrate along the to-be-cut line to obtain the finished non-slip mat;
step 8: completing the operation.

8. The non-slip mat production method described in claim 7, wherein the operation in step 1.2 to judge if the movable mould is displaced comprises the steps of:
step 1.2.1: collecting the image A of the hot melt table with the first camera; processing the image A with the image processor to obtain the contour line B1 of the positioning line;
step 1.2.2: collecting the initial image of the movable mould with the first camera; processing the initial image with the image processor to obtain the contour line B2 of the movable mould;
step 1.2.3: calculating the distance h1 between the contour line B1 and the contour line B2 to obtain the maximum value of the distance h, and write it as h1a;
step 1.2.4: comparing h1a with the first offset threshold Z1 that is set; judging that the movable mould is not displaced if h1a is not more than Z1; judging that the movable mould is displaced if h1a is more than Z1.

9. The non-slip mat production method described in claim 7, wherein the operation in step 6 to judge if the semi-finished non-slip mat is located in the trimming area comprises the steps of:
step 6.1: loading and preprocessing the third camera, so that the center of the trimming area captured by the third camera coincides with the centers of two cutters;
step 6.2: collecting the fourth image of the semi-finished non-slip mat with the third camera; using the visual processing module to process the fourth image to obtain the contour line B9 of the surface layer in the fourth image;
step 6.3: getting the central point O1 of the fourth image; carrying out the diagonal connection of the contour line B9; obtaining the central point O2 of the surface layer;
step 6.4: obtaining the distance H between the central point O1 and the central point O2, and comparing H with the set threshold Z5; judging that the semi-finished non-slip mat is located in the trimming area, and conducting step 7, if H is not more than Z5, and the center of the semi-finished non-slip mat coincides with the center of the trimming area; judging that the semi-finished non-slip mat is not located in the trimming area, and carrying out step 6.5, if H is more than Z5, and the center of the semi-finished non-slip mat doesn't coincide with the center of the trimming area; regarding the cumulative number of times for displacement of semi-finished non-slip mats as n+1;
step 6.5: calculating the actual distance H0 between the central point O1 and the central point O2 (H0=S×H: S is the magnification of the image captured by the third camera; His the distance between the central point O1 and the central point O2 on the image, and His a known parameter); driving the movement H0 of the semi-finished non-slip mat with the conveyor of the trimming machine, and conducting step 6.2;
step 6.6: judging if the number of times (n) for displacement of semi-finished non-slip mats is more than the set threshold; judging that the conveyor mechanism or/and the conveyor of the trimming machine is faulted, if yes; using the controller to suspend the conveyor mechanism or/and the conveyor of the trimming machine, to activate the alarm; conducting step 7, if not.

10. A non-slip mat, wherein the non-slip mat made by using the non-slip mat production method in claim 7 is composed of a surface layer, a substrate and a suction cup, the surface layer and suction cup are located on both sides of the substrate, and they are synchronously molten and welded together with the substrate.
